(19) United States
(12) Patent Application Publication
(10) Pub. No.: US 2006/0010056 A1
(43) Pub. Date: Jan. 12, 2006

(54) System and method for high-yield returns in riskless-principal interest rate/yield arbitrage

(76) Inventor: Alain L. De La Motte, Hillsboro, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/058,750

(22) Filed: Feb. 14, 2005

Related U.S. Application Data
(60) Provisional application No. 60/544,811, filed on Feb. 12, 2004.
(60) Provisional application No. 60/564,044, filed on Apr. 20, 2004.
(60) Provisional application No. 60/564,068, filed on Apr. 20, 2004.
(60) Provisional application No. 60/563,904, filed on Apr. 20, 2004.
(60) Provisional application No. 60/569,878, filed on May 10, 2004.
(60) Provisional application No. 60/615,130, filed on Oct. 1, 2004.

(51) Int. Cl. G06Q 40/00

(52) U.S. Cl. 705/35

(57) ABSTRACT

A system, method and strategy of investment can be executed in any currency and amount and, when constructed, can be executed and closed in certain steps to result in a pre-defined, guaranteed and quantifiable level of profitability for an investment without risk that the principal investment amount will be lost or depleted. The system, method and strategy also simultaneously guarantees the following results for all other transaction participants: (a) a pre-defined level of profit for the Investor and/or his Asset Manager (“Manager”) and the lender for the refinancing or discounting; (b) an option to call which when executed by the original issuer of the instruments will result in a profit for the original issuer (e.g. insurance companies, banks, brokerage firms, financial institutions, and/or corporations); (c) an exit strategy that allows each and every participant in the transaction to exit its original position without exposure to ongoing currency fluctuations, changes in interest rates and yields, or default by the issuers of financial products.

### CROSS-REFERENCE TO RELATED APPLICATIONS

This application claims priority to the following U.S. Provisional Patent Applications: (i) Ser. No. 60/544,811, filed Feb. 12, 2004 and entitled “System and Methodology for High-Yield Returns in Riskless-Principal Interest Arbitrage Involving Credit-Enhanced or Securitized Structured Derivative Products and/or Loans”; (ii) Ser. No. 60/564,044, filed Apr. 20, 2004 and entitled “System and Method to Increase the Refinancing Leverage in a Profitable Transaction Involving an Arbitrage of Yield Differentials Between Two Financial Products”; (iii) Ser. No. 60/564,068, filed Apr. 20, 2004 and entitled “System and Method for High-Yield Returns in Arbitrage of Yield Differentials Achieved Through: (a) Structured Insurance Products, and (b) the Exercise of Call and Put Options; (iv) Ser. No. 60/563,904, filed Apr. 20, 2004 and entitled “System and Method for an Insurance Company or a Bank to Increase its Sales and Subsequently its Profits Through the Repurchase (repo) of its Own Special Guaranteed Insurance Contract (or Bank Investment Contract) Purchased from an Unrelated 3^{rd} Party”; (v) Ser. No. 60/569,878, filed May 10, 2004 and entitled “System & Method for High-Yield Returns in Riskless-Principal Interest Rate/Yield Arbitrage that Calls for: (a) the Creation of Structured Derivative, Specialty Insurance or Synthetic Asset Products Specifically Engineered to Increase the Financial Leverage in a Transaction; (b) the Use of Option Agreements (Put & Call) to Arbitrage Market Differentials in Interest Rates & Yields, and (c) a “Repol” Mechanism to Create Immediate Profits for the Original Issuer”; (vi) Ser. No. 60/615,130, filed Oct. 1, 2004 and entitled “System & Method for Banks to Maintain Maximum Benefit Offered Member Banks by the Central Banks Through: (a) The Lending Leverage Available Under Fractional Reserve Banking Practices [e.g. 10:1 Leverage in the USA, 20:1 in Canada], and (b) Interest Rate Arbitrage [e.g. Retail Interest Rates less the Central Bank Discount Rate], Through a Mirror Offset of Counterparty Risk and Without Resorting to Traditional Repo Mechanisms; all of which are incorporated herein by reference.

### TECHNICAL FIELD

The invention relates to investment methods and arbitrage, and more specifically to System & Method for High-Yield Returns in Riskless-Principal Interest Rate/Yield Arbitrage that Calls for: (a) the Creation of Structured Derivative, Specialty Insurance or Synthetic Asset Products Specifically Engineered to Increase the Financial Leverage in a Transaction; (b) the Use of Option Agreements (Put & Call) to Arbitrage Market Differentials in Interest Rates & Yields, and (c) a “Repo” Mechanism to Create Immediate Profits for the Original Issuer.

### SUMMARY OF THE INVENTION

The invention may be thought of as a system and method for arbitrageurs, asset managers, investors or underwriters to immediately mine all built-in profits from a synthetic “riskless-principal”, simultaneous matched sale/purchase transaction. That transaction involves: (a) the underwriting of investment products engineered to yield a profit when resold or refinanced; (b) the exercise of a call option to facilitate the acquisition of an investment portfolio; (c) the exercise of an option to put the portfolio to a lender or buyer; (d) the arbitrage of yield/interest rate differentials achieved by discounting all future cash flows to their net present values; (e) the use of a refinancing mechanism to immediately liquify the investment; and (f) the use of a so-called “repo” mechanism/option to allow issuers to retire their own financial instruments at a profit so as to free-up balance sheet capacity for other profitable transactions (hereinafter the “Technology.”)

### DETAILED DESCRIPTION

The invention is described in the following attachments:

Attachment A—System and method for high-yield returns in “riskless-principal” interest rate/yield arbitrage that calls for: (a) the creation of structured derivative, specialty insurance or synthetic asset products specifically engineered to increase the financial leverage in a transaction; (b) the use of option agreements (put & call) to arbitrage market differentials in interest rates & yields, and (c) a “repo” mechanism to create immediate profits for the original user.

Attachment B—System and method for banks to maintain maximum benefit offered member banks by the central banks through: (a) the lending leverage available under fractional reserve banking practices (e.g. 10:1 leverage in the USA, 20:1 in Canada), and (b) interest rate arbitrage (e.g. retail interest rates less the central bank discount rate), through a mirror offset of counterparty risk and without resorting to traditional repo mechanisms.

Attachment C—Schematic diagrams and charts describing the invention.

Attachment D—System and methodology for high-yield returns in “riskless-principal” interest rate arbitrage involving credit-enhanced or securitized structured derivative products and/or loans.

Attachment E—System & method to increase the refinancing leverage in a profitable transaction involving an arbitrage of yield differentials between two financial products.

Attachment F—System & method for high-yield returns in arbitrage of yield differentials achieved through: (a) structured insurance products, and (b) exercise of call and put options.

Attachment G—System & method for an insurance company or a bank to increase its sales & subsequently its profits through the repurchase (repo) of its own special guaranteed insurance contract (or bank investment contract) purchased from an unrelated 3rd party.

The invention may also be described by the following numbered paragraphs:
1. A system, method and strategy of investment (the “Technology”), which can be executed in any currency and amount, and which, when constructed, executed and closed in the steps, method and an Investment Portfolio acquisition strategy described herein, will result in a pre-defined, guaranteed and quantifiable level of profitability for an investment without any risk whatsoever that the principal investment amount will be lost or depleted, while simultaneously guaranteeing the following results for all other transaction participants: (a) a pre-defined level of profit for the Investor and/or his Asset Manager (“Manager”) and the lender for the refinancing, discounting forfeiting¹ or factoring; (b) an option to call which when executed by the original issuer of the instruments will result in a profit for the original issuer (e.g. insurance companies, banks, brokerage firms, financial institutions, and/or corporations); (c) an exit strategy that allows each and every participant in the transaction to exit its original position without exposure to ongoing currency fluctuations, changes in interest rates and yields, or default by the issuers of financial products. This Technology comprises the following mechanisms and steps:
   ¹ Forfeiting is a method of financing (with fixed or floating interest rate) that eliminates all risks by selling a receivable on a “non-recourse” basis in exchange for immediately available cash.
   a. The fresh issue underwriting of two or more financial products (defined as a group as the “Investment Portfolio”) designed according to the following product specifications and features:
      i. Product No 1: A financial product, or Guaranteed Investment Contract² (“GIC”) issued by a rated³ financial institution or corporate issuer that matures at a future date (e.g. ten year maturity) and that has product features that function like a reverse annuity, and include the following features/provisions that are engineered to increase the borrowing leverage of the entire transaction described herein.
         ² According to Barron's Dictionary of Finance and Investment Terms (sixth edition), A Guaranteed Investment Contract is a contract between an insurance company . . . that guarantees a specific rate of return on the invested capital over the life of the contract . . . Although the insurance company takes all market, credit and interest rate risk on the investment portfolio, it can profit if its return exceeds the guaranteed amount . . . GICs are a conservative way of assuring beneficiaries that their money will achieve a certain rate of return (also called “Bank Investment Contract”).
         ³ Issuer rating or financial product rating issued by Standard & Poors, Moody's Financial Services, FitchRatings or Thompson Bankwatch, or any other such recognized rating institutions.
         1. Upon receipt of payment of the first annual installment, the issuer enters into a binding and irrevocable contract with the Investor/Holder to sell a financial product to the Investor/Holder based on pre-agreed terms and conditions.
         2. Payments of annual installments or agreed contract amounts occur that are payable in advance up to and including the last maturity year, with the first annual installment payable at the closing of the underwriting.
         3. A face value amount payable to the Investor/Holder of the instrument at maturity. The full face value pays if all annual installments have been made in a timely manner by the Investor/Holder throughout the life of the product.
         4. A pre-agreed fixed yield to maturity (the “YTM”) that is locked-in For the purpose of this description, the YTM for Product No 1 will be referred to as “YTM-1”.
         5. The inclusion of an option granted by the issuer to the Investor/Holder that would allow the Investor/Holder to “put” the financial instrument to the original issuer at any time prior to maturity at a pre-agreed set amount also called the cash surrender value.
         6. A matrix of premiums paid and cash surrender values that favor the issuer and disfavors the Investor/Holder if the instrument is cashed prior to maturity. This feature shifts the guaranteed future value of the instrument to the 10th year, so that if the policy is retired prior to the 10^{th} year, the cash surrender value will be less than the cumulative premiums paid. Therefore, if the instrument is surrendered for any reason prior to maturity, the surrender value paid by the original issuer will be less than the cumulative year-to-date premiums paid by the Investor/Holder, resulting in a gain for the issuer and a loss to the Investor/Holder. If the instrument is held to maturity, 100% of the guaranteed instrument value shifts to the Investor/Holder who receives the full benefit of the yield to maturity as a single payment of the principal and interest.
         7. The presence, if desired, and acceptable to the Investor/Holder, of an option for the issuer to “call” the instrument at any time prior to maturity based on the cash surrender value table or at any premium that may be added to it to it when the option is granted.
      ii. Product No 2: A financial instrument, guaranteed income contract or annuity issued by a rated financial institution or corporate issuer that provides the Investor/Holder with a guaranteed future cash flow stream payable by the issuer on each anniversary year during the life of the instrument. This instrument is designed so as to provide a cash flow stream to the Investor/Holder that is paid concurrently with the due date of each annual installment due for Product No 1, with features that function like a standard annuity product and includes the following:
         1. The price paid for this instrument is calculated by reducing all guaranteed future annual cash flows (“FV” or annual income earned from the investment) to their present values (“PV”), assuming a pre-agreed yield to maturity percentage (defined below). Upon payment of the purchase price, the issuer delivers this instrument at a simultaneous escrow closing.
         2. The cash flows from Product No 2 are fixed to coincide with the annual installment payments due under Product No 1 so that the income from Product No 2 automatically pays for the installments due under Product No 1 above.
         3. A pre-agreed and fixed built-in yield to maturity that is greater than YTM-1 (referred to herein as the “Yield Differential”). For the purpose of this description, the YTM for Product No 2 will be called “YTM-2”.
         4. The inclusion, if desired by the parties, of an option granted by the issuer to the Investor/Holder that would allow the Investor/Holder to “put” the financial instrument to the original issuer at any time prior to maturity at a pre-agreed price.
         5. The presence, if desired, and acceptable to the Investor/Holder, of an option for the issuer to “call” the instrument at any time prior to maturity based on a pre-agreed price.
         6. Important: Product No 2 can be replaced by a series of senior unsubordinated zero-coupon notes purchased from the issuer at a discount and that mature at annual intervals to coincide with the due date of the semi-annual interest payments. Product No 2 could also be replaced by a revolving standby letter of credit or bank guarantee that provides the same cash flow stream.
      iii. Product No 3: A financial instrument, guaranteed income contract or annuity issued by a rated financial institution or corporate issuer that provides the Investor/Holder with a guaranteed future cash flow stream payable by the issuer semi-annually during the life of the instrument. This instrument is designed so as to provide a stream of cash payments covering the semi-annual interest payments due under a fully defeased refinancing of the entire Investment Portfolio as described below, and includes the following features:
         1. The price paid for this instrument is calculated by reducing all guaranteed future semi-annual cash flows (“FV” or semi-annual income earned from the investment) to their present values (“PV”), assuming a pre-agreed yield to maturity percentage (defined in 3. below). Upon payment of the purchase price, the issuer delivers this financial instrument at a simultaneous escrow closing.
         2. The payment of the income to be derived from Product No 3 is timed to coincide with the interest payments due under the re-financing of the entire Investment Portfolio.
         3. A pre-agreed and fixed built-in yield to maturity that also delivers a positive Yield Differential. For the purpose of this description, the YTM for Product No 3 will be called “YTM-3”.
         4. The inclusion, if deemed desirable by the parties, of an option granted by the issuer to the Investor/Holder that would allow the Investor/Holder to “put” the financial instrument to the original issuer at any time prior to maturity at a pre-agreed price.
         5. The presence, if desired, and acceptable to the Investor/Holder, of an option for the issuer to “call” the instrument at any time prior to maturity based on a pre-agreed price.
         6. Important: Product No 3 can be replaced by a series of senior unsubordinated zero-coupon notes purchased from the issuer at a discount and that mature at intervals of every six months, with each maturity timed to coincide with due date of the semi-annual interest payment. This product can also be replaced by a revolving standby letter of credit or bank guarantee that provides the same cash flow stream as anticipated under Product No 3 above.
   b. The purchase of the Investment Portfolio consisting of either Products No 1, 2 and 3, or a stand-alone combination of Products No 2 and 3 occurs within a simultaneous escrow closing (all products, instruments, investment amounts, loan proceeds, certificates, powers of assignment, powers of attorney, underwriting agreements, tax opinions and legal opinions are delivered in escrow prior to closing). All steps of the transaction close simultaneously. Neither the delivery of the instruments, delivery of any purchase prices, nor any event required by the terms of any agreement between the parties shall be deemed to have occurred until such delivery, payment and all such events have occurred, and when such delivery, payment and all such events have occurred, they will be deemed to have occurred simultaneously. In the event the closing does not occur within the prescribed time frame for whatever reason, all funds, products, instruments, and other assets held in escrow are returned by the escrow agent to the original depositors and the closing is aborted, thus eliminating any and all transaction risks for all the parties.)
   c. The exercise of a call option, in escrow. Prior to closing the Investor/Holder shall have entered into an agreement with an unrelated third-party Manager, granting the Manager an option to “call” the Investment Portfolio of Investor/Holder at a pre-agreed price.
   d. A simultaneous Investment Portfolio refinancing mechanism directed or facilitated by the Manager in escrow that consists of either one of the following exit strategy options or any combinations thereof:
      i. A fully defeased⁴ refinancing of the Investment Portfolio (the “Loan”) provided by a bridge lender at a pre-agreed loan to value percentage (e.g. 96% loan to value which in this case is 96% of the face value of Product No 1 above) at an interest rate that is less than the melded yield to maturity achievable under the Investment Portfolio (the “Melded Returns”). The Loan principal is fully secured by a pledge of financial Products No 1 and 2 above and the proceeds to be derived therefrom. The semi-annual interest due on the Loan is fully secured by a pledge of financial Product No 3 above and the proceeds to be derived there from.
         ⁴ Barron's 4^{th} Edition, Dictionary of Banking Terms defines “Defeasance” as follows: “A Refinancing technique in which a bond issuer, instead of redeeming the bonds at the call date, continues to make coupon interest payments from an Irrevocable Trust and has deposited into the trust assets that will be used for the repayment of principal at maturity. The cash flow from trust assets, ordinarily U.S. Treasury securities or zero-coupon securities, must be sufficient to service the bonds until the expected maturity. Defeasance effectively removes the bonds from the issuer's balance sheets, even though the issuer continues to meet bond interest payments.”
      ii. The discounting⁵ of the income stream of financial or insurance products that make up the Investment Portfolio to its present value at a yield to maturity desired by a third-party buyer. In this case the melded yield to maturity offered the discount buyer must be lower than the Melded Returns achieved at closing in order to result in a profit to the Investor/Holder.
         ⁵ Barron's 2^{nd} Edition, Dictionary of Business Terms defines the term “Discounting” as “the process of estimating the present value of an income stream by reducing the expected cash flow to reflect the time value of money. Discounting is the opposite of compounding.”
      iii. The sale of the Investment Portfolio, directly or indirectly, to one of the original issuers of Products No 1, 2 or 3 above at a melded yield to maturity that is lower than the Melded Returns. In this case the melded yield to maturity offered the discount buyer must be lower than the Melded Returns achieved at closing in order to result in a profit to the Investor/Holder.
   e. The execution via simultaneous escrow closing of steps (a) through (d) above, leading to guaranteed and immediate profits for both the Investor/Holder and the Manager at closing. The profit represents the differential between the refinancing proceeds obtained from the application of one of the three options in paragraph (d) above and the cost of capital used to acquire the Investment Portfolio and. Since the Investment Portfolio is acquired and resold the same day via a simultaneous escrow closing, the transaction is deemed to be a “riskless principal” transaction where the refinancing proceeds are exchanged against delivery of all rights, title and interest to the Investment Portfolio to the lender. In anticipation that all rights, title and interest to the Investment Portfolio will be transferred to the lender, a novation⁶ agreement would be executed between buyer and seller to enable the Manager to remove the liability from its books and to immediately book the profit as earned income.
      ⁶ Barron's Dictionary of Finance and Investment Terms (6th Edition), defines the term “Novation” as follows: “(1) agreement to replace one party to a contract with a new party. The novation transfers both rights and duties and requires the consent of both the original and the new party” and “(2) replacement of an older debt or obligation with a newer one.”
   f. Steps (a) through (e) above can be executed repeatedly for the purpose of maximizing investment returns via the compounding of profits achieved through each successive investment cycle,⁷ or any other form of profit reinvestiment.
      ⁷ An Investment Cycle is defined as a series of steps (1) (a) through (e) above (hereinafter defined as a “Cycle”) that specifically include the purchase of certain financial products followed by a Refinancing occurring immediately thereafter that results in a net arbitrage profit at the end of each Cycle.
   g. The optional repurchase (“Repo”), by the original issuer of Product No 1, of one or more loan portfolios (secured by one or more Investment Portfolios) from any of the parties involved in the refinancing or repurchase contemplated in paragraphs (d) (i), (ii) or (iii) above with the intent of: (a) retiring Product No 1 for the purpose of capturing a significant immediate profit (the difference between the cumulative year-to-date installments paid on Product No 1 and the agreed-upon cash surrender value at the time of the Repo); (b) reselling the remaining portfolio in whole or in part to the original issuers, or to one or more third-party institutional buyers or managed funds or hedge funds; (c) freeing-up the issuer's in-house capacity so as to be able to reissue additional products without unreasonably inflating its balance sheet.
2. A system and methodology for a bank or financial institution (the “Issuer”) to issue and sell its own Products No 2 and/or Product No 3 (the “Financial Products”), or any other type of financial product described in sections 8, 9, 11, 12 below to a third-party buyer while retaining, or not, an option to repurchase (“Repo”) such product/s through the exercise of a call option in order to either: (i) retire said Financial Product/s from its books, or (ii) facilitate the creation of a series of newly issued derivative financial instruments that derive their value and credit worthiness from the repurchased Financial Products (the “Bank Technology”); whereas the overall intent and objective of the Issuer from the onset is as follows:
   (a) to book the proceeds from the sale of its Financial Products to a third-party Investor/Holder (the “Proceeds”) as Tier 2 capital on its balance sheet;
   (b) to have the complete use of the Proceeds for leveraging purposes⁸ (e.g. 10 to 1 in the United States, 20 to 1 in Canada, 12.5 to 1 in Europe) under the fractional reserve banking rules and regulations of the resident country's central banks or other regulatory banking institutions;
      ⁸ Amount that a bank can lend out with the refinancing support of its central bankers, money center banks, Home Mortgage Refinancing institutions or the global inter-bank refinancing markets (based on the London Inter-Bank Overnight Rate—“LIBOR”) based on the bank's balance sheet capital reserves. In the United States of America for instance, a bank can lend out $10 at retail for every $1 it maintains on its books as Tier 1 and/or Tier 2 Capital. Banks profit by leveraging the Proceeds from the sale of financial instruments through a process that involves: (a) the lending of available cash at retail interest rates followed by a refinancing of the collateral obtained as security on such loans (e.g. a mortgage or a note) at a lower discount rate; (b) the repetition of this lending and refinancing (to liquefy the collateral) cycle until such time as the full 10:1 leverage has been achieved. As an example, a bank that receives a $1 Million Proceeds for the sale of a ten-year financial instrument can achieve a gross profit of $1.09 Million over the same ten year period, assuming a leverage of 9 times Proceeds, a cost to the Issuer of 6.25% interest per annum, a reinvestment of 50% of the Proceeds in US Treasuries and 50% in retail mortgage, a revenue yield to maturity of 4.15% on US Treasuries, a revenue yield of 5.87% on mortgage loans, and a bank refinancing rate of 2.75%.
   (c) to use the maximum available leveraged amount for commercial lending and/or refinancing activities and purposes;
   (d) to facilitate on or off-balance sheet offset of counter-party risk;
   (e) to cooperate with other financial institutions or banks for the purpose of initiating, facilitating or enabling the consummation of a transaction consistent with the above objectives.
This Bank Technology comprises the following mechanisms and steps which are implemented at the tail-end of claim 1 above:
   2.1. The direct or indirect repurchase of the Financial Products by the original Issuer at a discounted price acceptable to the seller, either through: (a) the exercise of a put option by the original Investor/Holder or transferee of the Financial Products, or (b) the exercise of an option to call by the Issuer, or (b) the creation of a synthetic transaction where a third-party Manager simultaneously acquires the above Financial Products from the Investor/Holder, through the exercise of a call option, with the intent of putting same to the original Issuer as part of a put option agreement that shall have been pre-executed with the Issuer before exercising the call option.
   2.2. The stripping of principals and/or coupons from the original product, if necessary and/or the aggregation and separation of Financial Products into asset pools constituting similar Financial Products.
   2.3. The complete offset of counter risk accomplished through the cross issuance and acquisition of derivative products or credit-linked Notes (the “CLN/s”) within a repurchase transaction that has one or more of the following features or components: (a) two financial institutions agree to issue the Financial Products which are then purchase by a non-related, third-party Investor/Holder, (b) each of the two financial institutions issues its own CLN with the intent of swapping its CLN for the CLN of the other financial institution, (c) each CLN is securitized by the target counterparty's original Financial Products deposited in trust pursuant to a trust indenture (the “Underlying Asset”), (d) the Underlying Asset pool used for each CLN is that originally issued by the target swap counterparty so that each CLN derivates its creditworthiness and value from the asset pool issued by the same institution that is targeted to purchase the CLN (the intent being that the ultimate holder of the CLN is also the issuer of the Underlying Asset), (e) the swap of the CLN between the two original issuers.
   2.4. The engineering and subsequent cross issuance and sale or swap of a CLN to the target swap counterparty so as to enable each CLN issuer to hold a derivative instrument instead of having to repurchase and retire its own debt obligations that would prevent further profiting from the use of fractional reserve banking leverage and interest rate/discounting arbitrage involving the use of the Proceeds from the sale of the Financial Products.
3. A system in accordance with claim 1 where in said Product No 1 is replaced by an insurance policy, guaranteed insurance contract, revolving standby letters of credit or bank guarantees or any other type of financial instrument which replicates the construct of a reverse annuity.
4. A system in accordance with claim 1 wherein the maturity of said Product No 1 is shortened or lengthened to coincide with a desired portfolio maturity.
5. A system in accordance with claim 1 wherein the initial purchase payment installment for Product No 1 is increased or decreased relative to the face value payable at maturity so as to increase or decrease the financial leverage in the transaction (first installment amount divided by the face value payable at maturity).
6. A system in accordance with claim 1 wherein said Product No 1 is eliminated and replaced by extending the maturity of Product No 2 by one year and the first installment due under Product No 1 is applied to Product No 2.
7. A system in accordance with claim 1 wherein the cash surrender value of said Product No 1 is either increased or decreased, replaced by some other form of benefit, or where the redemption terms are extended or modified to increase or decrease the profit to the issuer in the event the issuer repurchases its own financial product at any time so as to retire it.
8. A system in accordance with claim 1 wherein said Product No 2 is replaced by one or more zero coupon notes, revolving or non-revolving standby letters of credit or bank guarantees, strips (“Strips” which are I/Os or P/Os purchased at a discount; e.g. US Treasury strips of “interest-only” or “principal-only”) that mature concurrently with the maturity date of any form of refinancing wherein the principal needs to be fully secured.
9. A system in accordance with claim 1 wherein said Product No 3 is replaced by a series of one or more zero coupon notes, revolving or non-revolving standby letters of credit, or bank guarantees, or Strips purchased at a discount and that are timed to mature concurrently with the due dates of each and every interest payment payable under a secured loan agreement or other form of refinancing where it is necessary to fully secure all future interest payments.
10. A system in accordance with claim 1 wherein said refinancing is fully defeased by either pledging a portfolio that consists of Products No 1, 2 and 3 above or other financial instruments provided for under claims 7 and 8 above as security thereby causing the refinancing to qualify as a fully or partially defeased transaction.
11. A system in accordance with claim 1 wherein said Products No 2 and No 3 are replaced by a single financial product that delivers the same features as contemplated for each of the two separate products (e.g. a medium-term note) that pays out a fixed principal amount at maturity and has monthly, quarterly, semi-annual or annual coupons attached that guarantee a future income stream timed to coincide with each future interest payment due date.
12. A system or method in accordance with claim 1 wherein Products No 2 and/or No 3 is/are replaced by a sinking fund or any other form of trust deposit of cash or marketable securities that guarantees the future payment or repayment of principal and/or interests on a loan or discounting arrangement, wherein such trust assets are used to secure future obligations under the terms and conditions of a trust indenture or any other form of trust arrangement between grantor and trustee.
13. A system or method in accordance with claim 1 wherein the investor, asset manager or arbitrageur use a special purpose or bankruptcy-remote company (“SPC”) to hold the portfolio and all secured debt obligations for the purpose of limiting the risk and/or maximizing the tax benefits to the investors.
14. A system or method in accordance with claim 1 wherein the simultaneous refinancing mechanism options envisioned in paragraph 1 (d) (i), (ii) or (iii) above are replaced by the creation of one or more derivative financial instruments (e.g. a senior secured note that derivates its value from the underlying assets deposited in trust—the “Derivative Instrument”) and the Derivative Instrument is secured by a combination of Products No 1, 2 and 3 above or other financial instruments provided for under claims 7 and 8 above and sold into the capital markets with the intent that the sales proceeds will be used to refinance or liquefy the Investment Portfolio.
15. A system or method in accordance with claim 1 wherein the refinancing mechanism options envisioned in paragraph 1 (d) (i), (ii) or (iii) above are replaced by the creation of one or more derivative financial instrument (e.g. a senior secured note that derivates its value from the underlying assets deposited in trust—the “Derivative Instrument”) and the Derivative Instruments are issued and sold simultaneously with the acquisition of Investment Portfolio.
16. A system or method in accordance with claim 1 wherein the anticipated defeased loan is replaced by a straight exit sale of the Investment Portfolio pursuant to the execution of a “novation” agreement that transfers all rights, title and interest to the buyer and allows the seller to remove both the asset and liabilities related to the Investment Portfolio and/or any bridge refinancing from its books.
17. A system or method in accordance with claim 1 wherein the repurchase mechanism (“Repo”) envisioned under 1 (g) above is accomplished through an exchange of stock or other financial instruments of the issuer as full and final settlement for the Repo.
18. A system or method in accordance with claim 1 wherein each step of the process envisioned in the simultaneous escrow closing are replaced by one or more escrow closings done at one or more escrow locations or venues and where the execution risks are eliminated through contractual agreements instead of a single escrow agreement between all the parties and the escrow agent.
19. A system or method in accordance with claim 1 wherein the purchase or refinancing of Products No 2 and 3 is accomplished through any form of: (a) intermediation by a financial institution for the purpose of transferring funds from an ultimate source to an ultimate user; (b) asset exchange involving swaps, options, swaptions or exchanges of like-value instruments, (c) instead of being bought with cash are secured by a pool of underlying assets, whether marginable or not, deposited with the issuing institution to guarantee the issuance of the financial instruments.
20. A system or method in accordance with claim 1 wherein financial products that make up the Investment Portfolio are in any denomination or currency, or have any future maturity.
21. A system or method in accordance with claim 1 wherein the refinancing of the Investment Portfolio is in any currency.
22. A system or method in accordance with claim 1 wherein the refinancing mechanism involves a Repo (repurchase by the original issuer) or a reverse Repo (repurchase by the original issuer with an added requirement that the same instrument will be later reacquired by the same seller).
23. A system or method in accordance with claim 1 wherein the Technology is implemented with or without hedging of currency or any other investment risk whatsoever.
24. A system or method in accordance with claim 1 wherein the refinancing of the Investment Portfolio is done through reinsurance.
25. A system or method in accordance with claim 1 wherein the registration of the Financial Products includes or not an original CUSIP⁹ or ISIN¹⁰ registration number (the “Registration Number”) to facilitate the settlement through one of the recognized fiduciary third-party settlement organizations whether such securities are issued in global form or not, and/or involve any form of securities swap/transfer implemented by a change of the Registration Number of the original securities.
   ⁹ CUSIP (“Committee on Uniform Securities Identification Procedures”) is a nine digit securities numbering system used in the US and Canada.
   ¹⁰ An International Securities Identification Number (ISIN) code consists of an alpha country code (ISO 3166) or XS for securities numbered by CEDEL or Euroclear, a 9-digit alphanumeric code based on the national securities code or the common CEDEL/Euroclear code, and a check digit.
26. A system or method in accordance with claim 1 wherein the Issuer or Financial Institution acts for its own account or as an intermediation party.
27. A system or method in accordance with claim 1 wherein a refinancing or Repo transaction is recognized on that party's balance sheet or alternatively is engineered as an off-balance-sheet financing or refinancing¹¹ for the purpose of not adding debt on a balance sheet that could potentially deteriorate the balance sheet ratios, whether or not such off-balance-sheet transaction involves the sale of receivables with recourse, take-or-pay contracts, bank financial instruments (e.g. guarantees, letters of credit, loan commitments) and whether such transaction involves or not a credit, market or liquidity risk.
   ¹¹ Definition as per Barron's “Dictionary of Finance & Investment Terms—6^{th} Edition” and as defined by Generally Accepted Accounting Principles (GAAP).
28. A system or method in accordance with claim 1 wherein one of the transaction engineering components which are part of the Technology results in an interest rate or yield to maturity differential, actual or synthetically created, and which is extracted as profit, on or off-balance sheet through a process of arbitrage, debt swap, forfaiting or discounting or the swap of future cash flow streams discounted to their present values.
29. A system or method in accordance with claim 2 wherein the Repo involves the use of put and call options or not, and with or without intent of creating a synthetic asset.
30. A system or method in accordance with claim 2 wherein the Repo involves or not the use of a credit derivative instrument (e.g. a CLN or other form of such instrument).
31. A system or method in accordance with claim 2 wherein the number of Issuers involve one, two or more CLN swap counterparties.
32. A system or method in accordance with claim 2 wherein the discount price/yield used to calculate the Repo or the swap price of the CLN is lower than that of the yield to maturity achieved under the original issue price of the Financial Products, which means that the Repo would result in a technical loss to the original issuer.
33. A system or method in accordance with claim 2 wherein the cross swap of the CLNs is achieved or arranged directly between the two swap counterparty financial institutions or through the intermediation services of a third financial institution acting as facilitator or any other third-party arranger or facilitator.
34. A system or method in accordance with claim 2 wherein the derivative CLN uses a form of trust-linked note or certificate or not.
35. A system or method in accordance with claim 2 wherein the security interest in the Underlying Asset is executed through the issuance of a credit-linked note (CLN) and whether or not the method of securing such CLN employs a trust indenture or any other form of securitization achieved through a trust or custodial form of third-party fiduciary arrangement.

The specific embodiments of the invention as disclosed and illustrated herein are not to be considered in a limiting sense as numerous variations are possible. The subject matter of this disclosure includes all novel and non-obvious combinations and subcombinations of the various features, elements, functions and/or properties disclosed herein. No single feature, function, element or property of the disclosed embodiments is essential. The following claims define certain combinations and subcombinations which are regarded as novel and non-obvious. Other combinations and subcombinations of features, functions, elements and/or properties may be claimed through amendment of the present claims or presentation of new claims in this or a related application. Such claims, whether they are different, broader, narrower or equal in scope to the original claims, are also regarded as included within the subject matter of the disclosure.

I claim:

1. A method of investment for an investor who works with an escrow manager, comprising
underwriting plural financial products;
purchasing an investment portfolio that includes at least some of the plural financial products by making and closing a single transaction within a preselected time period;
aborting the transaction if it does not close in the pre-selected time period;
exercising a call option in escrow;
initiating a simultaneous investment portfolio refinancing mechanism facilitated by an escrow manager according to preselected exit-strategy options; and
generating profits for the investor and escrow manager.

2. The method of claim 1 wherein the steps make up an investment cycle and wherein the steps are repeated to make plural investment cycles that maximize investment returns via the compounding of profits achieved through each successive investment cycle.

3. The method of claim 1 wherein one of the financial products is repurchased by the issuer of that one of the financial products.
